(19) United States
(12) Patent Application Publication
(10) Pub. No.: US 2024/0346244 A1
(43) Pub. Date: Oct. 17, 2024

(54) TRAINING MACHINE LEARNING SYSTEMS USING CUSTOM FEATURE ENGINEERING

(71) Applicant: Fujitsu Limited, Kawasaki-shi (JP)

(72) Inventors: Lei LIU, Sunnyvale, CA (US); Wei-Peng CHEN, Fremont, CA (US)

(73) Assignee: Fujitsu Limited, Kawasaki-shi (JP)

(21) Appl. No.: 18/299,651

(22) Filed: Apr. 12, 2023

(51) Int. Cl. G06F 40/20; G06F 40/30

(52) U.S. Cl. CPC G06F 40/20; G06F 40/30

(57) ABSTRACT

A system may include one or more processors configured to perform one or more operations including obtaining a dataset. The operations may additionally include training a language model to determine relationships between data in data subsets in the obtained dataset. Further operations may include extracting a value and a title from data subsets in the dataset, and determining a question based on the titles, the values, and a target variable. The operations may additionally include sending the question to the language model to obtain a vector. Further, the operations may include determining based on the vector, an operation that may be performed using the data. The operations may additionally include synthesizing data related to the target variable. In some embodiments, the operations may additionally include adding the synthesized data to one or more data subsets in the dataset and modifying a machine learning pipeline using thedataset.

### FIELD

The embodiments discussed in the present disclosure are related to training machine learning systems using custom feature engineering.

### BACKGROUND

Machine learning systems may be used in many technology sectors including but not limited to financial technologies, eCommerce, social media, gaming, facial recognition, and/or autonomous driving. These machine learning systems may be able to receive an input that may allow the system to learn and adapt to different sets of circumstances. In many cases, the input that the machine learning system may be able to receive may be a set or sets of data.

The subject matter claimed in the present disclosure is not limited to embodiments that sol ve any disadvantages or that operate only in environments such as those described above. Rather, this background is only provided to illustrate one example technology area where some embodiments described in the present disclosure may be practiced.

### SUMMARY

In an example embodiment, a system may include one or more processors and one or more non-transitory computer-readable storage media configured to store instructions that, in response to being executed, may cause the system to perform one or more operations, the operations may include obtaining a dataset including one or more data subsets. The operations may additionally include training a language model to determine relationships between data in the data subsets in the dataset using one or more question answer pairs. Further operations may include extracting a value and a title from each of at least two data subsets in the dataset, and determining a question based on the titles, the values, and/or a target variable inferred from data included in the dataset. In some embodiments, the operations may additionally include sending the question to the language model to obtain a vector, the vector may include one or more answers.

Further, the operations may include determining based on the vector, an operation that may be performed using the data that may be included in the at least two data subsets in the dataset. The operations may additionally include synthesizing data related to the target variable by performing the determined operation using the data that may be included in the at least two data subsets in the dataset. In some embodiments, the operations may additionally include adding the synthesized data to one or more new data subsets to the dataset. The operations may additionally include modifying a machine learning pipeline using the dataset where, in some embodiments, the modified machine learning pipeline may be configured to train one or more machine learning models using the dataset to make predictions using new data.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates an example environment for training one or more machine learning systems using the enhanced dataset;

FIG. 1B illustrates an example environment for training one or more language models;

FIG. 2 illustrates a flow chart of an example method of generating a consolidated dataset to modify a machine learning pipeline;

FIGS. 3A-3B illustrates a flow chart of an example method for generating features;

FIG. 4 illustrates a flow chart of an example method of modifying a machine learning pipeline using a dataset including generated and/or synthesized data subsets; and

FIG. 5 illustrates a block diagram of an example computing system.

### DETAILED DESCRIPTION

Machine learning systems, algorithms, neural networks, and the like are increasingly used particularly for tasks involving prediction. As used in the present disclosure, “machine learning systems” may include one or more algorithms, computer systems, neural networks, deep learning models, one or more other models, and/or one or more systems corresponding to the foregoing that may be configured to analyze one or more characteristics corresponding to input data.

While the development and/or use of these machine learning systems has increased over time, the development and training of the machine learning systems has become increasingly difficult and expensive. In many instances, developing and/or training machine learning systems may be time consuming and may include a large number of man hours and/or a great deal of professional expertise from data scientists and others. In some instances, data scientists and others may prepare datasets used in one or more machine learning pipelines to train one or more machine learning systems to perform a task.

In some instances, feature engineering may be employed to work with existing data in one or more datasets to train one or more machine learning systems. As used in the present disclosure, “feature engineering” may refer to any number of operations, such as mathematical operations and/or grouping operations, that may be designed to expand, contract, clean, filter, and/or clarify data within a given dataset. For example, feature engineering may refer to generating new data to add to a dataset, synthesizing data corresponding to existing data in the dataset, filtering out noisy data or data that may not be useful for a particular task, and other operations designed to modify a dataset that may be used to train one or more machine learning systems. Additionally, as used in the present disclosure, “features” may refer to one or more attributes and/or variables that may be present in a dataset. In some embodiments, variables may refer to a collection of similar data and/or information corresponding to the collection of similar data. In some embodiments, a feature, as used herein, may be contextualized in a dataset as a single column within the dataset and/or one or more other data subsets corresponding to the dataset.

In some instances, because feature engineering operations may require a significant number of man hours, automated processes may be preferred; however, one or more other automated machine learning algorithms and/or systems may have difficulty identifying relevant features, comparing those relevant features, and generating and/or synthesizing features that may improve the dataset via feature engineering. Therefore, manual avenues may be those typically taken to perform feature engineering on datasets, including large datasets.

For example, feature engineering may typically be performed by experienced data scientists who may add features to a dataset, remove feature redundancy in the dataset, and/or who may reduce dimensionality within the dataset. Furthermore, datasets that may be used to train machine learning systems may be large (e.g., on the order of thousands or millions of data points, or more). Indeed, many applications for machine learning may be benefited by training such machine learning systems with large datasets which, in turn, may require more time, more professional expertise, and more money to apply feature engineering functions that may create more effective datasets that may be used to train the machine learning systems.

One or more embodiments described in the present disclosure may decrease the cost (e.g., computing, human, and/or monetary costs) associated with performing feature engineering operations using a dataset. Further, one or more embodiments described in the present disclosure may correspondingly decrease the cost of synthesizing and/or generating one or more datasets used to train machine learning systems by automatically performing feature engineering processes using one or more language models to generate and/or synthesize one or more features. In some embodiments, the dataset including the one or more generated and/or synthesized features may be used to modify a machine learning pipeline so that the modified machine learning pipeline may be better suited to train one or more machine learning systems to perform a task.

In some embodiments, to better perform one or more feature engineering processes, a language model may be trained to find a similarity between features in a dataset using one or more question answer pairs. In some embodiments, the question in the one or more question answer pairs may compare data subsets within a particular category in the dataset. In some embodiments, the question in the one or more question answer pairs may be generated by determining one or more semantic similarity distributions between features in the dataset. The semantic similarity distributions may indicate one or more domains and/or categories that may describe data included in one or more features in the dataset. Further, in some embodiments, the answer in the one or more question answer pairs may be an answer to the question that may be determined and/or deemed correct based on a confidence value corresponding to the question reaching a particular threshold. In some embodiments, the question answer pairs may be used to train and/or fine-tune the one or more language models to analyze relationships between one or more features.

In some embodiments, to perform one or more feature engineering processes, one or more questions may be synthesized to elicit answers from the one or more language models. In some embodiments, the one or more language models may be trained using one or more question answer pairs. In some embodiments, the one or more language models may be configured to generate answers based on the one or more synthesized questions that may detail one or more relationships between features in the dataset.

In some embodiments, one or more operations to synthesize one or more additional features may be determined based on the answers from the one or more language models. The one or more operations may be configured to generate and/or synthesize data corresponding to features that may then be added to the dataset. In some embodiments, the dataset including the one or more generated and/or synthesized features may be used to modify one or more machine learning pipelines that may be configured to train one or more machine learning systems to perform one or more tasks.

According to one or more embodiments of the present disclosure, automatically generating and/or synthesizing features using one or more language models may increase efficiencies and/or decrease costs corresponding to one or more feature engineering processes. Further, in some embodiments, adding the one or more automatically generated and/or synthesized features to the dataset may improve the dataset by including additional data and/or information that may not be present in the dataset without the one or more generated and/or synthesized features. Additionally or alternatively, the one or more generated and/or synthesized features included with the data already present in the dataset may add additional context that may clarify one or more features in the dataset such that a machine learning system may be better equipped to perform one or more tasks based on the dataset including the generated and/or synthesized features than a machine learning system trained using the dataset without the generated and/or synthesized features.

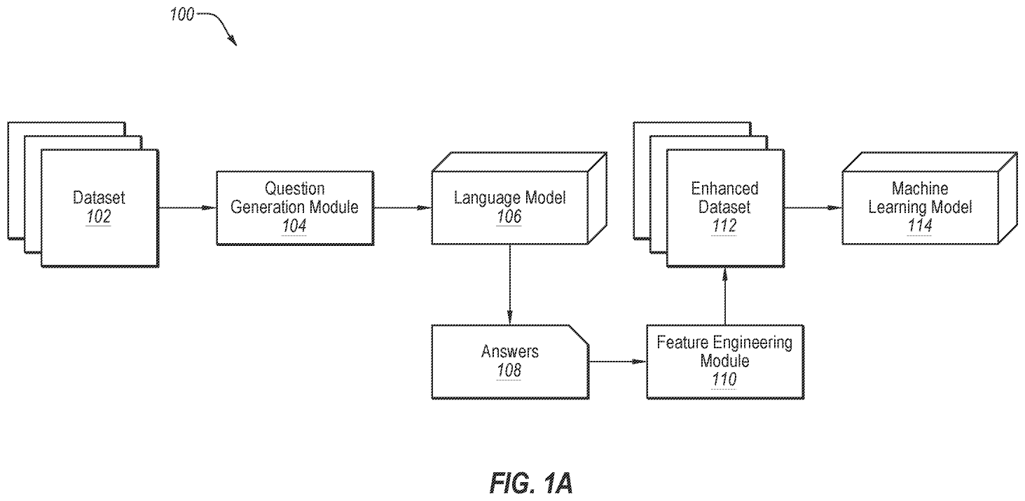

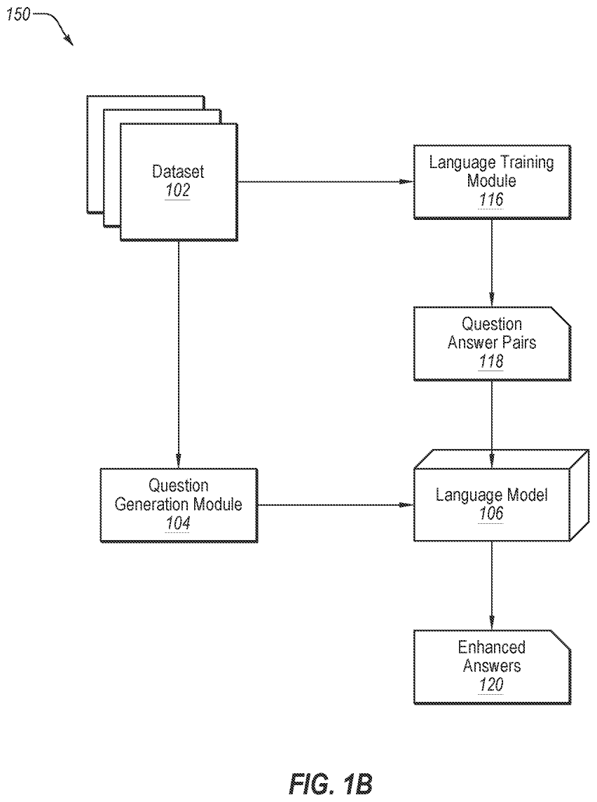

Turning to the figures, FIG. 1A illustrates an example environment 100 for training one or more machine learning models 114 using an enhanced dataset 112, in accordance with one or more embodiments of the present disclosure. The environment 100 may include a question generation module 104, a language model 106, and a feature engineering module 110 along with the machine learning model 114.

In some embodiments, the question generation module 104 may be configured to generate and/or synthesize one or more questions based on data included in a dataset 102. Additionally or alternatively, the language model 106 may be configured to generate one or more answers 108 based on the questions generated and/or synthesized using the question generation module 104. Additionally or alternatively, the feature engineering module 110 may be configured to synthesize data to add to the dataset 102 to create an enhanced dataset 112 based on the one or more answers 108. Additionally or alternatively, the enhanced dataset 112 may be used to train the machine learning model 114.

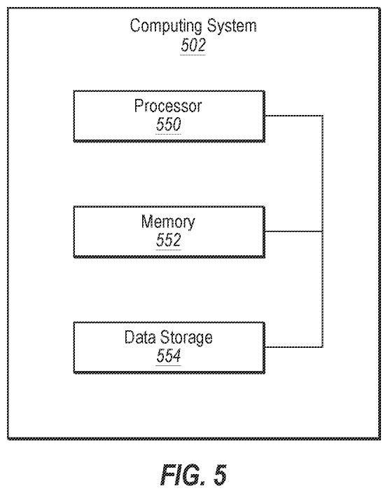

In these or other embodiments, the question generation module 104, the language model 106, the feature engineering module 110, and/or the machine learning model 114 may be implemented using hardware including one or more processors, central processing units (CPUs) graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In some other instances, one or more of these modules may be implemented using a combination of hardware and software. In the present disclosure, operations described as being performed by the question generation module 104 and/or the feature engineering module 110 may implemented by computer-readable instructions that may be executed and direct a corresponding computing system to perform the operations. In these or other embodiments, the question generation module 104, the feature engineering module 110, and/or the machine learning model 114 may be implemented by one or more computing devices, such as that described in further detail with respect to FIG. 5.

The dataset 102 may include data and/or identifiers corresponding to the data. In some embodiments, the data may include one or more values that may include any number of data types. For example, the data included in the dataset 102 may include integers, doubles, floats, chars, strings, Booleans, and any other data types that may convey information.

In some embodiments, the data included in the dataset 102 may include data that is associated based on the data corresponding to a particular object, concept, or construct. For example, the dataset 102 may include data corresponding to housing and/or property in a particular geographic area. Continuing the example, the dataset 102 may include data including property addresses, acreage, square footage in a house, number of adjacent properties, and any other data corresponding to housing and/or property in the particular geographic area.

In some embodiments, some of the data in the dataset 102 may be representative of a feature of the object, concept, or construct represented by the data. In some embodiments, the dataset 102 may include a number of data subsets where an individual data subset may include a title and any number of values. In these and other embodiments, the values representative of the same feature may be organized into one or more data subsets. For example, if the dataset 102 included information regarding homes, the title of the first data subset may be “total square feet” and each of the values may represent the “total square feet” of a corresponding home for that entry in the dataset 102.

In some embodiments, the values in each of the data subsets may be the same data type or may be a different data type. For example, each of the values in each of the data subsets of the dataset 102 may be integers. As an additional example, the values in a first data subset in the dataset 102 may be strings and the values in a second data subset in the dataset 102 may be integers. In some embodiments, a given data subset in the dataset 102 may include different data types. In these and other embodiments, the values of the dataset 102 may include integers, floating points, strings, characters, and/or any other data types that may convey information corresponding to data included in one or more data subsets in the dataset 102.

In some embodiments, a title in an individual data subset may correspond to values in the individual data subset. In some embodiments, the individual data subset may not include a title corresponding to the values. In some embodiments, the values included in the dataset 102 and/or individual data subsets may include corresponding units while some values included in the dataset 102 may not include units corresponding to the values included in the dataset 102.

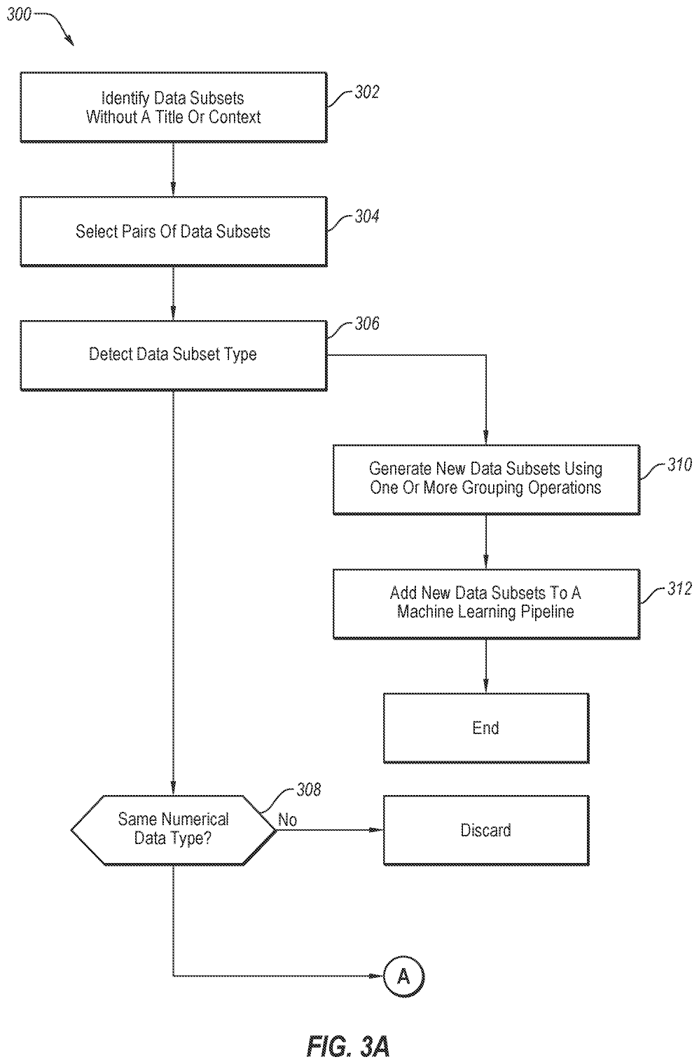

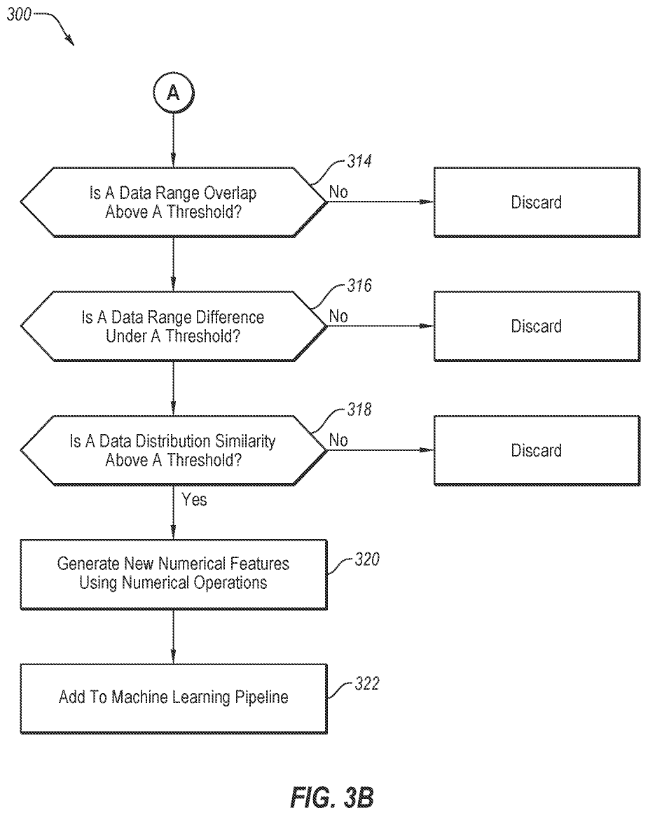

In some embodiments, data subsets not including titles or corresponding contextual information may be filtered out of the dataset 102. In some embodiments, one or more additional data subsets may be generated using the one or more data subsets that may not include titles and/or contextual information as described and/or illustrated further in the present disclosure, such as, for example, with respect to FIGS. 3A and 3B. Data subsets referred to in FIG. 1A may include those data subsets with a corresponding title and/or contextual information corresponding to data stored in the data subsets.

In some embodiments, the data subsets in the dataset 102 may each represent a distinct or different feature in the dataset 102. For example, the dataset 102 may include a first data subset and a second data subset where the first data subset may include values for a first feature and the second data subset may include values for a second feature. While the example of data subsets is utilized, any data storage or representation approaches may be undertaken, such as by storing the data associated with the feature in columns, rows, arrays, vectors, or using any other data storage approach.

In some embodiments, data included in the dataset 102 may include additional or explanatory information corresponding to the data and/or the features included in the dataset 102. In some embodiments, one or more data subsets included in the dataset 102 may include a description that may provide more information and/or context corresponding to the data and/or individual data subsets in the dataset 102. For example, a data subset including prices in dollars and cents may include a title “CAR_PRC.” Further, the data subset may include a description that may include explanatory information, such as, that the data included in the data subset includes prices for used cars sold in a particular city.

In some embodiments, the data subsets may include data and/or information that may either be categorized as numerical data or categorical data. As used in the present disclosure, numerical data describes data expressed in numbers. For example, a data subset in a dataset may include total square footage of homes in a neighborhood. Further, one or more data subsets including numerical data may be referred to herein as numerical data subsets.

In these or other embodiments, as used in the present disclosure, categorical data may describe a category, or a group typically expressed in characters and/or strings. For example, categorical data may include street names in a particular geographic area. Further, one or more data subsets that may include categorical data may be referred to herein as categorical data subsets.

In these and other embodiments, the dataset 102 may be stored in a comma separated values file type (“CSV”), Hierarchical Data Format (“HDF”), Java Script Object Notation (“JSON”), Text File (“TXT”), Structured Query Language (“SQL”) Database, or any other file type that may allow for the data subsets and the values in the dataset 102 to be stored and organized.

In some embodiments, the question generation module 104 may be configured to receive and/or otherwise obtain the dataset 102. In some embodiments, the question generation module 104 may be configured to analyze data included in the dataset 102 in order to generate and/or synthesize one or more questions for one or more language models (e.g., language model 106). In some embodiments, the question generation module 104 may generate questions to help determine one or more relationships between data included in data subsets in the dataset 102.

In some embodiments, the questions generated and/or synthesized using the question generation module 104 may be generated and/or synthesized to elicit an answer from the language model 106. In some embodiments, the question generation module 104 may generate and/or synthesize a question using a pair of data subsets. In some embodiments, the question generation module 104 may determine whether the pair of data subsets includes two numerical data subsets, two categorical data subsets, or one numerical data subset and one categorical data subset.

In some embodiments, the question generation module 104 may determine and/or identify that the pair of data subsets may both include numerical data subsets. In some embodiments, in response to identifying that both data subsets may include numerical data subsets, the question generation module 104 may be configured to select and/or import a question structure from a database of question structures. In some embodiments, the selected and/or imported question structure may be configured to elicit an answer from the language model 106 that may include a mathematical operation that may be performed on data that may be stored in the numerical data subsets. For example, the question structure that may be selected and/or imported may compare the two numerical data subsets and ask to determine a mathematical operation that may be performed on the data stored in the numerical data subsets. An example structure for generating a question using numerical data subsets is illustrated below:
Question: What is the most likely mathematical operation between [numerical data subset 1] and [numerical data subset 2]?

In some embodiments, the question generation module 104 may determine and/or identify that the pair of data subsets may include one numerical data subset and one categorical data subset. In some embodiments, in response to identifying that the data subset pair includes both a numerical data subset and a categorical data subset, the question generation module 104 may select and/or import a question structure from a database of question structures. In some embodiments, the question structure may be configured to elicit an answer 108 from the language model 106 where the answer 108 may include a grouping operation that may be performed on data stored in the numerical and categorical data subsets. For example, the question structure that may be selected and/or imported may compare the numerical data subset and the categorical data subset and ask to determine a grouping operation that may be performed on the data stored in the numerical data subset and the categorical data subset. An example structure for generating a question using numerical data subsets is illustrated below:
Question: What is the most likely [grouping operation] that may be performed using values of [numerical data subset] for each [categorical data subset] group?

In some embodiments, the question generation module 104 may determine and/or identify that the pair of data subsets may include both categorical data subsets. In some embodiments, in response to identifying that the data subset pair includes two categorical data subsets, the question generation module 104 may select and/or import a question structure from a database of question structures. In some embodiments, the question may be synthesized to elicit an answer that may include a grouping operation that may be performed on data stored in the categorical data subsets. An example structure for generating a question using numerical data subsets is illustrated below:
Question: What is the most likely [grouping operation] that may be performed using values of [categorical data subset 1] for each [categorical data subset 2] group?

In these or other embodiments, the question generation module 104 may use one or more target variables, titles, and/or values associated with the dataset 102 to generate a question for the language model 106 to elicit one or more answers 108 that may include operations that may be performed using data stored in the data subsets being compared.

In some embodiments, the question generation module 104 may be configured to determine one or more target variables. As used in the present disclosure, a “target variable” may refer to a variable that may be inferred from the dataset 102. For example, in the context of the dataset 102 including information regarding housing in a particular city, the target variable may be a variable that may reasonably be inferred using the dataset 102—e.g., house price(s) or predicted house price(s) in the particular city.

Additionally or alternatively, the target variable may include one or more tasks that one or more machine learning models (e.g., machine learning model 114) may be trained to perform. For example, a machine learning model 114 may be tasked with predicting housing prices. In response to the dataset 102 being used to train the machine learning model 114, the target variable may be house prices.

In some embodiments, the question generation module 104 may receive and/or otherwise obtain the target variable based on one or more tasks for a machine learning model 114 to perform. For example, the machine learning model 114 may be tasked with predicting white wine quality. Continuing the example, the question generation module 104 may obtain the task and a dataset 102 that may include data corresponding to white wine (e.g., pH, sulfur dioxide content, etc.). In these and other embodiments, the question generation module 104 may use the obtained target variable to synthesize and/or generate one or more questions to send to the language model 106.

In some embodiments, to synthesize and/or generate one or more questions, the question generation module 104 may be configured to extract titles corresponding to data subsets in the dataset 102. In some embodiments, the question generation module 104 may be configured to determine which data subsets to compare based on one or more similarity analyses. For example, the question generation module 104 may be configured to generate probability distributions using, for example, one or more semantic similarity analyses and/or lexical analyses to determine whether two or more data subsets may be comparable. Continuing the example, based on the probability distributions indicating that two or more data subsets may be comparable, the question generation module 104 may select the two or more data subsets to compare. In some embodiments, the question generation module 104 may be configured to extract titles from the two or more data subsets to generate one or more questions for the language model 106.

For example, the question generation module 104 may perform one or more semantic similarity analyses on each pair of data subsets in the dataset 102. The semantic similarity analyses may result in a respective probability distribution corresponding to each respective pair of data subsets in the dataset 102. The respective probability distributions indicating a probability that the data subsets in the respective pair of data subsets are semantically similar and/or comparable. Continuing the example, the question generation module 104 may compare the probability of pairs of data subsets being related as determined by the semantic similarity analyses. In response to the comparison of a pair of data subsets satisfying a threshold, the pair of data subsets may be used to generate and/or synthesize the one or more questions.

In some embodiments, the threshold may be determined based on one or more heuristic analyses. In some embodiments, it may be determined that a probability corresponding to a confidence percentage of over 90% produces synthesized questions comparing data subsets that are meaningfully similar. In some embodiments, comparing meaningfully similar data subsets may correspond to more accurate answers 108 from the language model 106, better synthesized data to add to the dataset 102 and better trained machine learning models 114 described and illustrated further in the present disclosure such as, for example, with respect to FIGS. 1A and 1B.

For example, in the context of the dataset 102 including data and/or information corresponding to properties in a particular city, the question generation module 104 may determine that the data subsets including data corresponding to first floor square footage and second floor square footage may be semantically similar and therefore useable in one or more generated and/or synthesized questions.

In some embodiments, by determining whether data subsets may be semantically similar, the question generation module 104 may not generate and/or synthesize a question corresponding to each data subset and/or pairs of data subsets in the dataset 102 thereby improving computing time, power, processing time, and improving the effectiveness of the enhanced dataset 112 in training one or more machine learning models 114.

In some embodiments, one or more titles corresponding to data subsets may be added to one or more question structures that may be selected and/or imported using the question generation module 104. An example question structure may be illustrated below:
Question: “What is the most likely relationship between [Title 1] and [Title 2]?
   Where Title 1 and Title 2 may correspond to titles of a first data subset and second data subset respectively in a pair of data subsets in the dataset 102.

In some embodiments, the question generation module 104 may be configured to provide additional context to the question structure that may be selected and/or imported using the question generation module 104. In some embodiments, additional context may include using one or more sample values included in the pairs of data subsets. An example question structure may be illustrated below:
Question: “What is the most likely relationship between [Title 1] with sample value [X] and [Title 2] with sample value [Y]?”
   Where X is a sample value corresponding to a data subset with the first title and where Y is a sample value corresponding to a data subset with the second title.

In some embodiments, the question generation module 104 may generate questions directed to one or more numerical comparisons in the event that each of the data subsets being compared include numerical values. In some embodiments, in response to the data subsets being compared including numerical values, the question generation module 104 may be configured to generate and/or synthesize one or more questions to determine one or more mathematical operations to compare the data included in the data subsets. Mathematical operations may include one or more of addition, subtraction, multiplication, division, summation, standard deviation, skew, etc.

For example, in the context of housing data in a particular location, a first data subset may include data indicating total square footage of homes in a particular location. Continuing the example, a second data subset may include values indicating total price corresponding to one or more houses in the particular location. Further, the question generation module 104 may be configured to identify that the values in the data subsets being compared may include numerical values. The question generation module 104 may additionally be configured to generate and/or synthesize one or more questions that may elicit answers 108 from the language model 106 to determine operations to perform using data in the dataset 102. The question generation module 104 may be configured to select and/or import a question structure that may include, for example, “What is the most likely mathematical operation between [Title 1] and [Title 2]?”

In some embodiments, the question generation module 104 may generate one or more questions directed to one or more categorical comparisons in the event that data subsets being compared include values with categorical data types. In some embodiments, in response to the data subsets being compared including categorical values and/or a mix of categorical and numerical values, the question generation module 104 may be configured to generate and/or synthesize one or more questions to determine one or more grouping operations to compare the data included in the data subsets.

In some embodiments, grouping operations may depend on whether values corresponding to the data subsets being compared may include numerical and categorical values or only categorical values. In some embodiments, comparisons made using data subsets including both categorical and numerical values may include a mathematical grouping operation such as one or more of a summation, a standard deviation, a skew, a maximum, a minimum, a mean, a median, etc. In some embodiments, comparisons made using data subsets including only categorical values may include mathematical grouping operations, for example, most common value, least common value, etc.

For example, the question generation module 104 may be configured to identify two data subsets, a first data subset including numerical values and a second data subset including categorical values. The first data subset may include values corresponding to lot area in square feet and the second data subset may include values corresponding to street groups that may be categorized by name. Further, the target variable may be house price or predicted house price. Continuing the example, the question generation module 104 may be configured to generate one or more questions corresponding to the first data subset and the second data subset to determine whether one or more grouping operations may be useful in determining one or more target variables. The question generation module 104 may select and/or import a question structure corresponding to comparing a numerical data subset and a categorical data subset. The selected and/or imported question structure including, for example:
Question: To predict [target variable], are the [mathematical grouping operation] values of [numerical data subset] for each [categorical data subset] group useful?

Further, the question generation module 104 may be configured to add data and/or information corresponding to the numerical data subset and the categorical data subset. The question including the added data corresponding to the numerical data subset and the categorical data subset may include, for example:
Question: “to predict house price, are the minimum values of lot size for each street group useful?”
   Where “minimum” values may be an example of a mathematical grouping operation that may be performed using the numerical data subset and the categorical data subset.

As an additional example, a first data subset may include categorical values and a second data subset may include categorical values. The first data subset may include road type access corresponding to residential areas in a city, and the second data subset may include neighborhood groups corresponding to the residential areas in the city. Continuing the example, where the target variable may again be house price, the question generation module 104 may be configured to select and/or import a question structure that may be designed to compare categorical data subsets. The question structure may include, for example:
Question: To predict [target variable], is the [categorical grouping operation] [categorical data subset] for each [categorical data subset] group useful?

Further, the question generation module 104 may be configured to add data and/or information corresponding to the categorical data subsets. The question including the added data corresponding to the categorical data subsets may include, for example:
Question: “to predict house price, is the most common road type access for each neighborhood group useful?”
   Where “most common” may be an example of a grouping operation that may be performed using data included in categorical data subsets.

In some embodiments, one or more improvements may be made to the questions generated and/or synthesized using the question generation module 104 that may increase an accuracy of the answers 108 generated using the language model 106. In some embodiments, the one or more improvements to the questions may include, for example, replacing data subset names with expanded data subset names, providing one or more potential answers 108 with the generated and/or synthesized questions, and/or training the language model 106 to answer the one or more generated and/or synthesized questions.

In some embodiments, the question generation module 104 may be configured to generate one or more questions that may replace data subset titles with additional explanatory information corresponding to the data subsets. In some embodiments, one or more data subset names may typically include abbreviations and/or titles that may not be descriptive. Therefore, in some embodiments, including additional explanatory information corresponding to the data subsets being compared may provide additional context for the language model 106. In some embodiments, providing additional context with one or more generated and/or synthesized questions may elicit more accurate answers 108 to the question than answers 108 elicited using only the titles corresponding to the data subsets in the dataset 102.

For example, the question generation module 104 may compare a first data subset that may include a first title, “HSE_REMOD” and a second data subset including a second title, “HSE_YR.” Continuing the example, the first data subset may include an additional data subset explanation that may include, at least in part, “the year of a house remodel” and the second data subset may include additional information that may include, at least in part, “the year the house was built.” Further, instead of the question generation module 104 generating a question that may read, “what is the most likely mathematical operation between HSE_REMOD and HSE_YR?” the question may read, “what is the most likely mathematical operations between the year of a house remodel and the year the house was built?” The second question may include more context such that the language model 106 may be better able to answer the question in a more accurate manner than the question not including the additional information.

In some embodiments, the question generation module 104 may be configured to generate one or more questions that may provide one or more potential answers with the generated and/or synthesized questions. In some embodiments, providing one or more potential answers to the language model 106 may increase a likelihood that the language model 106 may correctly, or more accurately, predict an answer 108 corresponding to the generated and/or synthesized question.

For example, continuing in the context of the first data subset including a year of a house remodel and the second data subset including information corresponding to the year a house was built, the question may read, “what is the most likely mathematical operation between the year of a house remodel and the year a house was built?” Further, the question may additionally include a number of potential answers to the question—e.g., “addition, subtraction, multiplication, or division.” In total, the question that may be sent to the language model 106 may include: “what is the most likely mathematical operation between the year of a house remodel and the year a house was built, Addition, subtraction, multiplication, or division?” Where the language model 106 may be configured to make a determination between the potential answers provided.

In some embodiments, the question generation module 104 may be configured to generate one or more question answer pairs that may train the language model 106 to answer the one or more generated and/or synthesized questions. In some embodiments, one or more question answer pairs may be generated and/or synthesized to illustrate one or more potential questions corresponding to one or more potential answers. In some embodiments, by training the language model 106 using one or more example question answer pairs, the language model 106 may be better suited to accurately answer one or more other questions where answers may not be given. In some embodiments, one or more example question answer pairs may be generated and/or synthesized to train the language model 106 based on each domain of potential answers 108 (e.g., addition, subtraction, multiplication, division, maximum, minimum, summation, standard deviation, skew, most common value, least common value, and other arithmetic and grouping operations that may be performed on values included in the dataset 102).

In some embodiments, the example question answer pairs may be used as context to be sent with an additional question to the language model 106. In some embodiments, the question answer pairs may be sent independently from the additional question to train the language model 106 in advance to answer questions generated using the question generation module 104 more accurately than the language model 106 may be configured to answer the question without being trained. In these and other embodiments, training the language model 106 using one or more example question answer pairs may be described and illustrated further in the present disclosure, such as, for example, with respect to FIG. 1B.

In some embodiments, the one or more questions generated using the question generation module 104 may be sent to the language model 106. In some embodiments, the language model 106 may be configured and/or trained to answer the one or more generated and/or synthesized questions.

In these and other embodiments, the language model 106 may include a pre-trained large language model which may include language models such as Generative Pre-Trained Transformer 3 (“GPT3”), Bidirectional Encoder Representations from Transformers (“BERT”), Robustly Optimized Bidirectional Encoder Representations from Transformers (“ROBERTa”), Text-to-Text Transfer Transformer (“T5”), and other language models designed to receive the question synthesized and provide an answer 108 that may include one or more operations that may be performed using data stored in data subsets in the dataset 102.

In some embodiments, the language model 106 may be configured to generate one or more answers 108 to the synthesized question. In some embodiments, the one or more generated answers 108 may be chosen out of a discrete number of potential answers. In some embodiments, synthesizing a question that may compare data subsets in the dataset 102 may include a discrete number of mathematical operations that may be possible to perform on the data in the numerical data subsets. For example, the mathematical operations to perform may include addition, subtraction, multiplication, division, etc. Additionally or alternatively, the generated answer 108 may include only two options—e.g., true or false, yes or no, etc.

In some embodiments, the one or more generated answers 108 may include more nuance than a discrete number of answers 108. For example, in the context of determining a white wine quality, a question may be synthesized that may be sent to the language model 106, the question including: “to predict white wine quality, are the skewness values of density in each of the sulphate groups useful?” Continuing the example, the language model 106 may generate an answer 108 that may include more than a “yes” or a “no” The answer 108 may include, “No, however, the percentages of each sulphate group are useful in predicting white wine quality.”

In some embodiments, the one or more generated answers 108 may include one or more vectors, matrices, arrays, tensors and/or other collection of values that may indicate probability distributions corresponding to one or more answers 108 to the generated and/or synthesized questions. In some embodiments, the language model 106 may generate a probability distribution for each of the possible answers 108 to the generated and/or synthesized questions or, at least, the one or more answers 108 that the language model 106 may recognize as possible answers 108 to the synthesized question.

In some embodiments, one or more generated answers 108 may be interpreted and/or used by the feature engineering module 110 to synthesize and/or generate additional values that may be added to the dataset 102. In some embodiments, the feature engineering module 110 may be configured to perform one or more operations to synthesize data in the dataset 102 based on the one or more generated answers 108 being correct. In some embodiments, the one or more generated answers 108 may be deemed correct based on a confidence value satisfying a threshold, where the confidence value may be determined based on one or more probability distributions corresponding to the one or more answers 108.

In some embodiments, the threshold that may be satisfied may be determined based on an accuracy and/or size of the model. For example, a T5-11b model may be better able to consistently satisfy higher threshold confidence percentages than a T5-3b model. In some embodiments, the opposite may be true where smaller models may be better able to consistently generate answers 108 and higher corresponding confidence percentages than a larger language model.

In some embodiments, the threshold may be determined based on an amount of computing power, storage, time, processing power, etc. that may be available. For example, computing time and processing power may be very high. In this instance, the threshold may be set relatively low—e.g., 50% which may result in more answers may be processed, more operations may be performed, more data subsets may be generated which may result in a larger dataset with which to modify a machine learning pipeline. In some embodiments, the opposite may be true, where the threshold may be set high—e.g., 99% which may result in fewer answers 108 that may be deemed correct, fewer operations to perform, fewer new data subsets to add to the dataset 102.

In some embodiments, the threshold may be determined based on one or more heuristic analyses. In some embodiments, it may be determined that the language model 106 may determine mostly correct answers 108 at a particular threshold—e.g., a confidence percentage of 85% or more. In these and other embodiments, using one or more heuristic analyses to synthesize one or more questions and generating one or more answers 108 may be described and/or illustrated further in the present disclosure, such as, for example, with respect to FIGS. 3A and 3B.

In some embodiments, the feature engineering module 110 may be configured to determine one or more operations to perform based on a majority of answers 108 that may have been generated using the language model 106. In some embodiments, the language model 106 may provide multiple answers 108 to a single question. Further, the feature engineering module 110 may determine which operation to perform using the data stored in the data subset pairs based on a majority of the answers 108 indicating the same operation.

In some embodiments, the feature engineering module 110 may be configured to perform one or more operations using the answers 108 to determine one or more operations to perform using the data stored in the one or more data subsets of the dataset 102. In some embodiments, the language model 106 may be configured to answer one or more questions regarding categorical data subsets where the answers 108 may include a “yes” or a “no.” Additionally or alternatively, the answers 108 may include an explanation—e.g., “no, however . . . ,” “yes, but . . . ,” etc. In these or other embodiments, the feature engineering module 110 may be configured to perform one or more lexical analyses and/or sentiment analyses to determine whether the one or more grouping operations proposed using the one or more questions may be useful in determining the target variable.

In some embodiments, the lexical analyses may be performed to determine whether one or more words is present in the answer 108, for example “yes” or “no.” In some embodiments, a sentiment analysis may be performed to determine whether the answer 108 was positive or negative. In some embodiments, the answer 108 may include, for example, the word “yes” but may include additional information such that the total sentiment of the answer is negative. In some embodiments, using a sentiment analysis may allow the feature engineering module 110 to make more accurate determinations based on the answers 108 as compared to one or more lexical analyses, for example.

For example, in the context of the dataset including data related to the passengers on the Titanic, a question may be synthesized using a numerical data subsets “number of spouses/siblings” and “Age” respectively. Continuing the example, the target variable for the dataset 102 may be survival rate, and the question synthesized may seek to determine whether there may be a correlation between the target variable and the numerical data subsets through a grouping operation, in this instance, the grouping operation is minimum. The question synthesized may read, “To predict Titanic survival rate, are the minimum values of Age for each number of spouses/siblings group useful?” Further, the language model may answer, “no, however the maximum values may be useful.” Further continuing the example, the feature engineering module 110 may be configured to perform a lexical analysis to determine whether to generate a new data subset by determining the minimum value of age for each number of spouses/siblings group based on whether the answer includes “yes” or “no.” Additionally or alternatively, the feature engineering module 110 may be configured to perform one or more sentiment analyses to determine whether the answer, overall, was “positive” or “negative” toward the question synthesized.

In some embodiments, the feature engineering module 110 may determine one or more operations to perform on existing data in the dataset 102. In some embodiments, the feature engineering module 110 may perform the one or more determined operations to synthesize data that may be added to the dataset 102 based on the one or more generated answers 108.

For example, the dataset 102 may include a first data subset and a second data subset that may be compared. The first data subset may include a first title “1 stFlrSF” corresponding to the square footage of a first floor of a house and the second data subset may include a second title, “2ndFlrSF” corresponding to the square footage of a second floor of a house. Continuing the example, the question generation module 104 may synthesize a question corresponding to the first and second data subsets. The question may include, “to predict house price, what is the most likely mathematical operation between 1stFlrSF and 2ndFlrSF? Addition, subtraction, multiplication, or division?” Further the question may be sent to the language model 106 that may generate a vector including probability distributions corresponding to each of the potential answers 108—addition, subtraction, multiplication, and division. The language model 106 may indicate that the mathematical operation to be performed is addition with a confidence value corresponding to a confidence percentage of 95% which may satisfy a threshold for performing the operation. In response to the answer 108 and the corresponding confidence value, the feature engineering module 110 may perform an addition operation using the first data subset and the second data subset. The feature engineering module 110 may generate a new data subset with data synthesized by adding the data in the first data subset and the data in the second data subset together to create a data subset that may be represented using a title, “1stFlrSF+2ndFlrSF.” Further continuing the example, the feature engineering function 110 may add the data subset and corresponding data to the dataset 110. The dataset 102 with the added synthesized data may be described in the present disclosure as the enhanced dataset 112.

In some embodiments, the feature engineering module 110 may be configured to generate the enhanced dataset 112 where the enhanced dataset 112 may include the dataset 102 and one or more additional data subsets including synthesized data using the dataset 102. Additionally or alternatively, the enhanced dataset 112 may include fewer data subsets than the dataset 102. In some embodiments, the enhanced dataset 112 may be used to train one or more machine learning models 114 to perform one or more tasks.

The machine learning model 114 may be any suitable system, apparatus, or device configured to be trained using the enhanced dataset 112 to perform a given task. In some embodiments, the machine learning model 114 may be configured to receive and/or otherwise obtain the enhanced dataset 112 that may have been generated using the feature engineering module 110. In some embodiments, the enhanced dataset 112 may be used to train the machine learning model 114 to complete the given task. In some embodiments, the given task may include making a prediction, identifying relationships, or any other task that may be performed using one or more machine learning models 114.

As an example, the machine learning model 114 may include an algorithm configured to predict prices of residential homes. In this example, the machine learning model 114 may obtain the enhanced dataset 112 that may have a first data subset with values that represent “location” and a second data subset with values that represent “last sale price.” The enhanced dataset 112 may be used to train the machine learning model 114 to perform its target function of predicting a price of a given residential home based on other data such as the location and the last sale price.

In another example, the machine learning model 114 may include an algorithm configured to predict prices of residential homes. Continuing the example, the machine learning model 114 may receive the enhanced dataset 112 that may have the first data subset with values that represent “location” and the second data subset with values that represent “last sale price” as illustrated in the above example with respect to the enhanced dataset 112. Additionally, the enhanced dataset 112 may include a third data subset with values that may represent “square footage,” and a fourth data subset with values that may be generated by the feature engineering module 110 representative of a “price per square foot.” The enhanced dataset 112 may be used to train the machine learning model 114 to predict a price of a given residential home. Further continuing the example, in response to the additional feature, “price per square foot,” being added to the dataset 102 when generating the enhanced dataset 112, the machine learning model 114 that may obtain the enhanced dataset 112 may be able to predict a price of a given residential home with more accuracy than if the machine learning model 114 had been trained only using the data included in the dataset 102.

Modifications, additions, or omissions may be made to FIG. 1 without departing from the scope of the present disclosure. For example, the amount of data included in the dataset 102, the number of questions generated using the question generation module 104, the number of language models 106 and/or answers 108 generated using the language model 106, the number of features in the enhanced dataset 112 may vary.

FIG. 1B illustrates an example environment 150 for training and/or fine-tuning one or more language models 106, in accordance with one or more embodiments of the present disclosure. The environment 150 may include a language training module 116, the language model 106, and the question generation module 104.

In these or other embodiments, the environment 150 may be the same as the environment 100. Further, the dataset 102, the question generation module 104 and the language model 106 may be the same as, and/or analogous to, those described with respect to FIG. 1A.

In some embodiments, the dataset 102 may include one or more different datasets. In some embodiments, the dataset 102 may be a different dataset 102 used to generate and/or synthesize one or more new features using the language model 106 (e.g., using the question generation module 104) than another dataset 102 that may be used to generate one or more question answer pairs 118 using the language training module 116. In some embodiments, the dataset 102 used to generate question answer pairs 118 using the language training model 116 and used to generate and/or synthesize one or more new features using the language model 106 may be the same.

In these or other embodiments, the language training module 116 may be implemented using hardware including one or more processors, central processing units (CPUs) graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In some other instances, one or more of these modules may be implemented using a combination of hardware and software. In the present disclosure, operations described as being performed by the language training module 116 may implemented by computer-readable instructions that may be executed and direct a corresponding computing system to perform the operations. In these or other embodiments, the language training module 116 may be implemented by one or more computing devices, such as that described in further detail with respect to FIG. 5.

In some embodiments, the language training module 116 may be configured to receive and/or otherwise obtain the dataset 102. In some embodiments, the language training module 116 may be configured to analyze one or more characteristics of the data stored in the dataset 102, one or more features or data subsets that may be included in the dataset 102, and/or additional information corresponding to the data stored in the dataset 102. For example, the dataset 102 may include additional information explaining that the dataset 102 includes data corresponding to traffic accidents in a particular city during a particular time. Continuing the example, the language training module 116 may be configured to analyze data included in the dataset 102 along with the additional context that the data stored in the data 102 may be related to traffic accidents in the particular city at the particular time.

In some embodiments, the language training module 116 may be configured to generate one or more question answer pairs 118 using data stored in the dataset 102. In some embodiments, the language training module 116 may be configured to generate and/or synthesize one or more question answer pairs 118 based on the target variable and the data types corresponding to the data stored in the dataset 102.

In some embodiments, the language training module 116 may generate and/or synthesize one or more question answer pairs 118 that may not be associated with the dataset 102. In some embodiments, the language training module 116 may obtain, generate, and/or synthesize one or more question answer pairs 118 that may not include data stored in the dataset 102, but that may be similar to data in the dataset 102.

In some embodiments, the language training module 116 may be configured to generate and/or synthesize one or more questions using data stored in the dataset 102. Further, the language training module 116 may be configured to generate one or more answers corresponding to the one or more generated and/or synthesized questions. In some embodiments, the one or more questions and corresponding answers may be configured to train and/or fine-tune the language model 106 to better understand and/or answer the questions synthesized and/or generated using the question generation module 104.

In some embodiments, the language training module 116 may be configured to perform one or more similarity analyses to determine which data subsets and/or features corresponding to the dataset 102 may be used in the question answer pairs 118. For example, the language training module 116 may be configured to generate probability distributions using, for example, one or more semantic similarity analyses and/or lexicographical analyses to determine whether two or more data subsets in the dataset 102 may be comparable. Continuing the example, based on the probability distributions indicating that two or more data subsets may be comparable, the language training module 116 may be configured to extract titles, values, explanatory information, and/or any other information corresponding to the data subsets to generate and/or synthesize one or more questions and one or more corresponding answers for the question answer pairs 118.

For example, the language training module 116 may perform one or more semantic similarity analyses on each pair of data subsets in the dataset 102. The semantic similarity analyses resulting in a respective probability distribution corresponding to each respective pair of data subsets in the dataset 102. The respective probability distributions may indicate a probability that the data subsets in the respective pair of data subsets are semantically similar and/or comparable. Continuing the example, the language training module 116 may determine that the pairs of data subsets that may correspond to a probability of being related based on the semantic similarity analyses that may satisfy a threshold. In response to the probability satisfying the threshold, the pair of data subsets may be used to generate and/or synthesize the one or more questions.

In some embodiments, the data subsets chosen for question answer pairs 118 may be chosen in response to the data subsets being the most comparable data subsets as compared to other data subset pairs in the dataset 102. For example, the language training module 116 may compare data and/or information corresponding to each of the data subsets in the dataset 102. Continuing the example, the language training module 116 may extract information from three data subset pairs to generate and/or synthesize three question answer pairs 118. Further continuing the example, the language training module 116 may select the three data subset pairs that may have the highest three semantic similarity scores which may indicate that the three data subset pairs are the three most comparable data subset pairs in the dataset 102.

In some embodiments, the language training module 116 may be configured to generate and/or synthesize one or more question answer pairs 118 based on possible answers that may be used by the language model 106. In some embodiments, the language training module 116 may compare data subsets including numerical data. In some embodiments, in response to identifying that the data included in the data subsets being compared may include numerical data, the language training module 116 may include one or more answers in the question answer pairs 118 that may correspond to one or more mathematical operations that may be performed using the numerical data in the data subsets. The mathematical operations including, for example, addition, subtraction, multiplication, division, etc.

For example, the language training module 116 may identify that the dataset 102 may include one or more data subsets that may include numerical data. Continuing the example, in response to identifying that data included in the one or more data subsets may include numerical data, the language training module 116 may generate and/or synthesize one or more question answer pairs 118 that may include question structures selected and/or imported using one or more databases. The questions may be synthesized using information corresponding to comparable data subsets and selected question structures corresponding to numerical data subsets. The question answer pair 118 may read:
“Question: What is the most likely mathematical operation between [numerical data subset 1] and [numerical data subset 2]? Answer: Addition.”

In some embodiments, the language training module 116 may compare data subsets including categorical data. In some embodiments, in response to identifying that the data included the dataset may include categorical data, the language training module 116 may select and/or import one or more question structures drafted to compare categorical data subsets. Further, the questions may be synthesized using the selected question structures and data corresponding to the categorical data subsets. Further, in some embodiments, one or more answers in the question answer pairs 118 may correspond to one or more grouping operations that may be performed using the categorical data in the data subsets. The grouping operations including, for example, summation, standard deviation, skew, maximum, minimum, mean, median, most common value, least common value, etc. For example, the question answer pair 118 may read,
“Question: To predict [target variable] are the maximum values of [data subset to be acted on] for each [data subset to be grouped] group useful? Answer: Yes”

In some embodiments, the question answer pairs 118 may be generated and/or synthesized to provide examples, train and/or fine-tune to the language model 106 to recognize one or more questions synthesized using the question generation module 104. Further, training and/or fine-tuning the language model 106 using one or more question answer pairs 118 may increase an ability of the language model 106 to more readily and accurately answer the questions generated and/or synthesized using the question generation module 104. In some embodiments, the question answer pairs 118 may include examples of questions eliciting answers for each of the possible mathematical operations and/or grouping operations.

For example, in the context of the dataset 102 including data corresponding to computer programs, codes, associated documentation and data, etc., the question generation module 104 may be configured to generate an example question answer pair 118 for one or more mathematical domains—e.g., addition, subtraction, multiplication, and division. Example question answer pairs 118 corresponding to each listed mathematical domain are illustrated using the expressions below:
Question 1: What is the most likely mathematical operation between the number of bugs and the number of issues? Addition, subtraction, multiplication, division?
Answer 1: Addition
Question 2: What is the most likely mathematical operation between total lines of code and line with issues? Addition, subtraction, multiplication, division?
Answer 2: Subtraction
Question 3: What is the most likely mathematical operation between PERCENT COMMENTS and NUMBER OF LINES? Addition, subtraction, multiplication, division?
Answer 3: Multiplication
Question 4: What is the most likely mathematical operation between PARAMETER COUNT and NUMBER OF LINES? Addition, subtraction, multiplication, division?
Answer 4: Division

In some embodiments, the question answer pairs 118 may be used to train and/or fine-tune the language model 106 to better recognize the questions and to more accurately generate and/or synthesize answers to the questions.

In some embodiments, the one or more question answer pairs 118 may be sent with the one or more questions generated and/or synthesized using the question generation module 104. The one or more question answer pairs 118 may serve as additional context for the language model 106 to more accurately answer the questions generated and/or synthesized using the question generation module 104.

In some embodiments, the language model 106 may use the one or more question answer pairs 118 to better answer questions generated and/or synthesized using the question generation module 104. In some embodiments, the language model 106 may be configured to generate one or more enhanced answers 120 using the question answer pairs 118 to train and/or fine-tune the language model 106 to answer questions generated and/or synthesized using the question generation module 104.

In some embodiments, the enhanced answers 120 may include one or more answers that may be generated with an increased confidence percentage using the language model 106. In some embodiments, the enhanced answers 120 may include answers that may be correct answers to the questions generated and/or synthesized using the question generation module 104 more often than the answers 108 generated and/or synthesized without using the question answer pairs 118.

Modifications, additions, or omissions may be made to FIG. 1B without departing from the scope of the present disclosure. For example, the amount of data included in the dataset 102, the number of questions generated using the question generation module 104, the number of language models 106, the number of question answer pairs 118 generated using the language training module 116, and/or the number of enhanced answers 120 that may be generated using the language model 106.

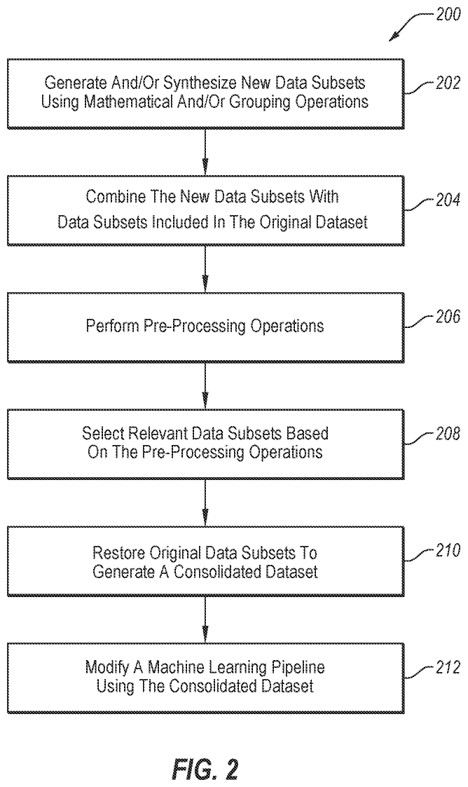

FIG. 2 illustrates a flow chart of an example method 200 of generating a consolidated dataset to modify a machine learning pipeline, in accordance with one or more embodiments of the present disclosure. The method 200 may be performed by any suitable system, apparatus, or device including the question generation module 104, the language module 106, and the feature engineering module of FIG. 1A, and/or the language training module 116 of FIG. 1B. The method 200 may include one or more blocks 202, 204, 206, 208, 210, and 212. Although illustrated with discrete blocks, the steps and operations associated with one or more of the blocks of the method 200 may be divided into additional blocks, combined into fewer blocks, or eliminated, depending on the particular implementation.

In some embodiments, the method 200 may include block 202. At block 202, one or more new data subsets may be generated using data synthesized using one or more mathematical and/or grouping operations. In some embodiments, the one or more operations that may be performed on data included in the dataset may be determined using one or more answers received and/or otherwise obtained from one or more language models. In some embodiments, performing the one or more operations may generate and/or synthesize data that may be included in one or more new data subsets. As used in the present disclosure, “new data subsets” may refer to data subsets separate from the data subsets originally included in a dataset (e.g., the dataset 102). The new data subsets may be generated using data that may have been synthesized using data originally included in the dataset. In these or other embodiments, generating questions to elicit answers from a language model to determine one or more operations to perform using data included in the dataset 102 may be described and/or illustrated further in the present disclosure, such as, for example, with respect to FIGS. 1A and 1B.

At block 204, the one or more new data subsets may be combined with the data subsets included in the original dataset. In some embodiments, the combination of the new data subsets with the data subsets included in the original dataset may be referred to as an enhanced dataset. In these and other embodiments, the enhanced dataset described herein may be analogous to the enhanced dataset 112 described and/or illustrated in the present disclosure, such as, for example, with respect to FIGS. 1A and 1B.

At block 206, one or more pre-processing operations may be performed using one or more data subsets included in the enhanced dataset. In some embodiments, the pre-processing operations may include comparing data included in one or more of the data subsets to data included in one or more of the other data subsets included in the enhanced dataset. In some embodiments, each of the data subsets may be compared to each of the other data subsets in the enhanced dataset.

In some embodiments, the data included in the data subsets may be compared using one or more comparison metrics. In some embodiments, the one or more comparison metrics may be configured to determine how related data included in one or more data subsets may be to data included in one or more other data subsets. In some embodiments, the one or more comparison metrics may include mutual information analyses, the Pearson correlation coefficient, chi2, Analysis of Variance (ANOVA), F-Value, and other comparison metrics that may be configured to compare data included in the data subsets stored in the enhanced dataset.

For example, one or more mutual information analyses may be used to compare the data subsets stored in the enhanced dataset. Reference to mutual information analyses may include one or more statistical measurements corresponding to the data shared between two data subsets. Continuing the example, data included in each of the data subsets stored in the enhanced dataset may be compared with each of the other data subsets stored in the enhanced dataset. Further, each data subset pair may be assigned a value that may indicate an amount of information overlapping between the data included in the two data subsets. In some embodiments, the one or more pairs of data subsets that may have been compared using one or more mutual information analyses may be classified, rank ordered, or otherwise labeled according to mutual information scores corresponding to the one or more pairs of data subsets.

At block 208, one or more data subset pairs may be selected based on the one or more pre-processing operations. In some embodiments, one or more data subset pairs may be selected based on a comparison metric score satisfying a particular threshold. In some embodiments, the threshold may include selecting one or more data subset pairs based on a percentile corresponding to the comparison metric scores. In some embodiments, a percentage of data subset pairs may be selected in response to the comparison metric scores being in the top 1, 5, 10, 15, 20, 25, 30, or some other percent of comparison metric scores as compared to all of the data subset pairs stored in the enhanced dataset. In some embodiments, the threshold may be determined based on an amount of computing power, storage, time, processing power, etc. that may be available. In some embodiments, the threshold may be determined automatically based on a percentage of data subsets included in the original dataset. In some embodiments, it may be determined that one or more new data subsets may be determined up to a threshold percentage (e.g., 60, 70, 80, 90, 100% or some other percent) of the data subsets in the original dataset. For example, the original dataset may include 400 original data subsets, it may be determined that no more than 75% of the number of data subsets included in the original dataset should be generated as new data subsets (e.g., no more than 300 new data subsets). In some embodiments, the data subset pairs that may not have satisfied the particular threshold may be filtered out of the enhanced dataset.

At block 210, the original data subsets may be restored to the enhanced dataset. In some embodiments, reference to original data subsets may refer to data subsets included in the dataset prior to synthesizing and/or generating new data to add to the dataset. In some embodiments, the enhanced dataset including the original data subsets and the new data subsets that may have satisfied the particular threshold using one or more comparison metrics may be referred to as the consolidated dataset. In some embodiments, the consolidated dataset may include only the original data subsets. In some embodiments, the consolidated dataset may include all of the data subsets included in the enhanced dataset. In some embodiments, the consolidated dataset may include more data subsets than the original dataset, but fewer data subsets than in the enhanced dataset.

At block 212, a machine learning pipeline may be modified using the consolidated dataset. In some embodiments, the machine learning pipeline may be configured to train one or more machine learning models to perform one or more tasks. In some embodiments, modifying the machine learning pipeline using the consolidated dataset may improve performance of one or more machine learning models trained using the machine learning pipeline. For example, the machine learning model trained using the consolidated dataset may be better at predicting and/or inferring one or more characteristics corresponding to new data than a machine learning model trained using one or more other datasets (e.g., the dataset 102 and/or the enhanced dataset 112 described and/or illustrated with respect to FIGS. 1A and 1B).

Modifications, additions, or omissions may be made to the method 200 without departing from the scope of the present disclosure. For example, the operations of method 200 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

FIGS. 3A-3B illustrate a flow chart of an example method 300 for generating data subsets, in accordance with one or more embodiments of the present disclosure. The method 300 may be performed by any suitable system, apparatus, or device including the question generation module 104, the language module 106, and the feature engineering module 110 of FIG. 1A, and/or the language training module 116 of FIG. 1B. The method 300 may include one or more blocks 302, 304, 306, 308, 310, 312, 314, 316, 318, 320, and 322. Although illustrated with discrete blocks, the steps and operations associated with one or more of the blocks of the method 300 may be divided into additional blocks, combined into fewer blocks, or eliminated, depending on the particular implementation.

At block 302, one or more data subsets stored in a dataset may be identified. In some embodiments, the data subsets may include data subsets without a corresponding title. Additionally or alternatively, one or more data subsets may be identified based on one or more corresponding titles that may not provide sufficient information to determine a context corresponding to the data stored in the data subset. Further, the data subsets identified may not include any additional information or identifiers that may provide context corresponding to the data subsets. For example, the data subset may include a title, “A” and a number of numerical entries corresponding to the title. Continuing the example, the title “A” may not be descriptive of anything related to the numerical entries; further, the data subset may not indicate any other information or context corresponding to the data subset. In response to the data subset not including context corresponding to data stored in the data subset, the data subset may be identified and/or selected.

In some embodiments, it may be determined that all of the data subsets stored in the dataset may include a title and/or sufficient context to synthesize one or more questions to elicit answers from a language model. In these or other embodiments, the dataset including titles and/or sufficient context corresponding to each data subset may proceed with generating new data stored in new data subsets described and illustrated further in the present disclosure, such as, for example, with respect to FIGS. 1A, 1B, and 2.

At block 304, one or more data subset pairs may be selected out of the data subsets identified at block 302. In some embodiments, one or more data subset pairs may be selected by pairing each of the data subsets identified at block 302 with each of the other data subsets identified at block 302.

In some embodiments, one or more data subset pairs may be selected based on one or more similarity measures, functions, metrics, etc. that may evaluate similarity between data stored in one or more data subset pairs. In some embodiments, one or more techniques may be used to evaluate an amount of similarity associated with data subset pairs including, for example, correlation analyses (e.g., Pearson correlation coefficient), distance metrics (e.g., Euclidean distance, Manhattan distance, cosine distance, etc.), clustering techniques (e.g., K-means clustering, hierarchical clustering, density-based clustering, etc.), mutual information techniques, and other data comparison techniques that may determine similarity between data stored in one or more data subset pairs. In some embodiments, the data subset pairs may be selected based on the one or more similarity analyses—e.g., based on a particular similarity score. In some embodiments, a data subset pair may be selected based on a corresponding data similarity score being above a percentage. For example, the data subset pair may be selected based on the corresponding similarity score being in the top 5, 10, 20, 25, 30, 35 or some other percent of similarity scores compared to similarity scores corresponding to each of the other data subset pairs identified at block 302.

At block 306, a data subset type may be determined for one or more data subsets in the data subset pairs selected at block 304. In some embodiments, a data subset type may be determined for each of the data subsets in each of the data subset pairs. In some embodiments, each of the data subsets may be determined to be numerical data subsets or categorical data subsets based on the data stored in each of the data subsets. In some embodiments, a data subset pair may include two numerical data subsets, two categorical data subsets, or one numerical data subset and one categorical data subset. In the instance that the data subset pair includes two numerical data subsets, the method may proceed to block 308. In the instance that the data subset pair includes at least one categorical data subset type, the method may proceed to block 312.

At block 308, it may be determined whether a data type corresponding to both numerical data subsets may be the same numerical data type. In some embodiments, to determine whether the data types corresponding to data stored in the numerical data subsets are the same, the data type corresponding to each of the numerical data subsets may be detected. In some embodiments, the data type may include an integer, float, double, long, short, byte, and any other data type that may correspond to numerical data. In some embodiments, in the event that the numerical data types corresponding to each of the numerical data subsets are not the same, the data subset pair may be discarded or otherwise not considered for generating and/or synthesizing new data to add to the dataset. In some embodiments, in the event that the data type corresponding to each of the data subsets in the data subset pair may be the same, the method may proceed to block 324 described and illustrated with respect to FIG. 3B.

At block 310, one or more new data subsets may be generated and/or synthesized using one or more grouping operations. In some embodiments, one or more grouping operations may be determined based on the data subset type corresponding to the data subset pair. In some embodiments, it may be determined that the data subset pair may include both a numerical data subset and a categorical data subset. In some embodiments, it may be determined that the data subset pair may include two categorical data subsets.

In some embodiments, one or more new data subsets may be generated using one or more grouping operations using a data subset pair including both a numerical data subset and a categorical data subset. In some embodiments, the grouping operations may include numerical grouping operations. The numerical grouping operations may include, for example, a summation, a standard deviation, a skew, a maximum, a minimum, a mean, a median, and other grouping operations that may be performed using data corresponding to both a numerical data subset and data corresponding to a categorical data subset.

In some embodiments, one or more new data subsets may be generated using one or more grouping operations using a data subset pair including categorical data subsets. In some embodiments, the grouping operations may include categorical grouping operations. The categorical grouping operations may include, for example, a unique value, a most common value, frequency, percentage, entropy, and other grouping operations that may be performed using data corresponding to categorical data subsets. In these or other embodiments, the categorical grouping operations may be the same as those described in the present disclosure, such as, for example, with respect to FIGS. 1A, 1B, and 2. In some embodiments, data subsets generated and/or synthesized using one or more grouping operations may be referred to herein as “new data subsets.” In some embodiments, the method may continue with the new data subsets at block 312.

At block 312, the new data subsets may be added to a machine learning pipeline. In some embodiments, the new data subsets may be added to the dataset (e.g., the dataset 102) where the dataset may be used to modify a machine learning pipeline that may be configured to train one or more machine learning models. In some embodiments, one or more of the new data subsets may be filtered out of the dataset used to modify the machine learning pipeline using, for example, one or more processes described and/or illustrated in the present disclosure, such as, for example, processes corresponding to the consolidated dataset in FIG. 2. In some embodiments, after adding the new data subsets to the dataset, the method may end.

In some embodiments, the method 300 may include block 314 that may correspond to FIG. 3B. At block 314, it may be determined whether a data range overlap may be above a threshold. In some embodiments, to determine whether the data range overlap corresponding to data in the numerical data subset pair is above a threshold, a data range overlap may be detected and/or determined. In some embodiments, the data range overlap may correspond to overlap in data included in the numerical data subset pair(s) that may have been selected and filtered at, for example, blocks 304, 306, and/or 308. In some embodiments, the data range overlap may be determined using a data subset pair that may include a first numerical data subset and a second numerical data subset. Further, the data range overlap may be determined by identifying a first data range corresponding to data included in the first numerical data subset and by identifying a second data range corresponding to data included in the second numerical data subset. The first data range and the second data range may then be compared to determine an overlapping region of data, or a lack thereof.

In some embodiments, it may be determined that an overlapping data range corresponding to the numerical data subset pair may be above a threshold. In some embodiments, the threshold may be based on one or more heuristic analyses. For example, it may be determined that data corresponding to two numerical data subsets with a data range overlap of under a particular percentage, such as 50, 65, 75 or some other percent, may not be useful in synthesizing new data or may not be as useful in synthesizing new data as data subset pairs including a data range overlap of over a particular percentage, such as 50, 65, 75 or some other percent. In some embodiments, one or more machine learning models may be deployed to learn a threshold from past data. In some embodiments, a reinforcement learning algorithm (e.g., included in and/or performed in conjunction with one or more machine learning models) may be used to gradually learn what thresholds may result in synthesizing new data that may not be relevant or may not be as relevant in training one or more machine learning models to make predictive judgments regarding one or more target variables as compared to one or more other thresholds. In some embodiments, using less relevant or irrelevant new data may result in less accurate predictions using the machine learning model than predictions that may be made by the machine learning model that may have been trained using relevant data. For example, the reinforcement learning algorithm may be configured to learn that one or more thresholds including a data range overlap under a particular percentage may result in synthesizing less relevant new data to train one or more machine learning models as compared with one or more other thresholds including a data range overlap over a particular percentage, such as, 50, 60, 75 or some other percent. In some embodiments, the threshold may be simplified as a binary indicator to show whether the data range overlaps. In some embodiments, the threshold may be determined based on an amount of computing power, storage, time, processing power, etc. that may be available. In some embodiments, in the event the numerical data subset pair includes a data range overlap under the threshold, the numerical data subset pair may be discarded, filtered out, and/or or otherwise not considered to generate and/or synthesize new data to add to the dataset. In some embodiments, in the event that the numerical data subset pair includes a data range overlap over the threshold, the method may proceed to block 316.

At block 316, it may be determined whether a data range difference may be under a threshold. In some embodiments, to determine whether the data range difference corresponding to data in the numerical data subset pair may be under a threshold, a data range difference may be detected and/or determined. In some embodiments, a data range difference may be determined between data included in the numerical data subset pair. In some embodiments, the data range difference may refer to an extent that data included in the first numerical data subset and data included in the second numerical data subset do not share common values. In some embodiments, the data range difference may refer to determining the values unique to each of the numerical data subsets in the numerical data subset pair.

In some embodiments, it may be determined that the data range difference may be under a particular threshold. In some embodiments, the threshold may be based on one or more heuristic analyses. For example, it may be determined that data corresponding to two numerical data subsets with a data range difference of above a particular percentage, such as, 10, 20, 30 or some other percent may not be useful in synthesizing new data or may not be as useful in synthesizing new data as data subset pairs including a data range difference under a particular percentage, such as, 10, 20, 30 or some other percent. In some embodiments, one or more machine learning models may be deployed to learn and/or determine a threshold from past data. In some embodiments, a reinforcement learning algorithm (e.g., included in and/or performed in conjunction with one or more machine learning models) may be used to gradually learn what thresholds may result in synthesizing new data that may not be relevant or may not be as relevant in training one or more machine learning models to make predictive judgments regarding one or more target variables as compared to one or more other thresholds. In some embodiments, using less relevant or irrelevant new data may result in less accurate predictions using the machine learning model than predictions that may be made by the machine learning model that may have been trained using relevant data. For example, the reinforcement learning algorithm may be configured to learn that one or more thresholds including a data range difference above a particular percentage may result in synthesizing less relevant new data to train one or more machine learning models as compared with one or more other thresholds including a data range difference under a particular percentage, such as, 10, 20, 30 or some other percent. In some embodiments, the threshold may be simplified as a binary indicator to show whether a data range difference exists between the data corresponding to the two numerical data subsets. In some embodiments, the threshold may be determined based on an amount of computing power and/or time to determine the data range difference. Further, the threshold may be determined based on a size of the dataset including one or more new data subsets. In some embodiments, in the event the numerical data subset pair includes a data range difference over the threshold, the numerical data subset pair may be discarded, filtered out, and/or otherwise not considered to generate and/or synthesize new data to add to the dataset. In some embodiments, in the event that the numerical data subset pair includes a data range difference under the threshold, the method may proceed to block 318.

At block 318, it may be determined whether a data distribution similarity may be above a threshold. In some embodiments, to determine whether the data distribution similarity corresponding to data in the numerical data subset pair may be above a threshold, a data distribution similarity may be detected and/or determined. In some embodiments, a data distribution similarity may be determined between data stored in the numerical data subset pair. In some embodiments, one or more data distribution similarity metrics and/or scores may be used to determine a similarity between data included in the numerical data subset pair. For example, one or more of mutual information analyses, the Pearson correlation coefficient, chi2, Analysis of Variance (ANOVA), F-Value, Kolmogorov-Smirnov test (ks-test), and other comparison metrics that may be configured to compare data included in the numerical data subsets stored in the numerical data subset pair.

In some embodiments, it may be determined that the data distribution similarity may be above a particular threshold. In some embodiments, the threshold may be based on one or more heuristic analyses. For example, it may be determined that data corresponding to two numerical data subsets with a data distribution similarity of under a particular percentage, such as, 60, 65, 70, 75, 80 or some other percent may not be useful in synthesizing new data or may not be as useful in synthesizing new data as data subset pairs including a data range difference above a particular percentage, such as, 60, 65, 70, 75, 80 or some other percent. In some embodiments, a machine learning model may be deployed to learn a threshold from past data. In some embodiments, a reinforcement learning algorithm (e.g., included in and/or performed in conjunction with one or more machine learning models) may be used to gradually learn what thresholds may result in synthesizing new data that may not be relevant or may not be as relevant in training one or more machine learning models to make predictive judgments regarding one or more target variables as compared to one or more other thresholds. In some embodiments, using less relevant or irrelevant new data may result in less accurate predictions using the machine learning model than predictions that may be made by the machine learning model that may have been trained using relevant data. For example, the reinforcement learning algorithm may be configured to learn that one or more thresholds including a distribution similarity under a particular percentage may result in synthesizing less relevant new data to train one or more machine learning models as compared with one or more other thresholds including a distribution similarity over a particular percentage, such as, 60, 65, 70, 75, 80 or some other percent. In some embodiments, the threshold may be determined based on an amount of computing power, storage, time, processing power, etc. that may be available. In some embodiments, in the event the numerical data subset pair includes a data distribution similarity under the threshold, the numerical data subset pair may be discarded or otherwise not considered to generate and/or synthesize new data to add to the dataset. In some embodiments, in the event that the numerical data subset pair includes a data distribution similarity above the threshold, the method may proceed to block 320.

At block 320, one or more new numerical data subsets may be generated and/or synthesized using one or more mathematical operations. In some embodiments, the mathematical operations may include, for example, addition, subtraction, multiplication, division, and other mathematical operations that may be performed using data corresponding to the numerical data subset pair. In these or other embodiments, the mathematical grouping operations may be the same as those described in the present disclosure, such as, for example, with respect to FIGS. 1A, 1B, and 2. In some embodiments, data subsets generated and/or synthesized using one or more mathematical operations may be referred to herein as “new numerical data subsets.”

At block 322, the new numerical data subsets may be added to a machine learning pipeline. In some embodiments, the new numerical data subsets may be added to the dataset (e.g., the dataset 102) where the dataset may be used to modify a machine learning pipeline that may be configured to train one or more machine learning models. In some embodiments, the dataset may include both new numerical data subsets and new categorical data subsets that may be added to the dataset at, for example, block 312.

In some embodiments, one or more of the new numerical data subsets may be filtered out of the dataset used to modify the machine learning pipeline using, for example, one or more processes described and/or illustrated in the present disclosure, such as, for example, processes corresponding to the consolidated dataset in FIG. 2.

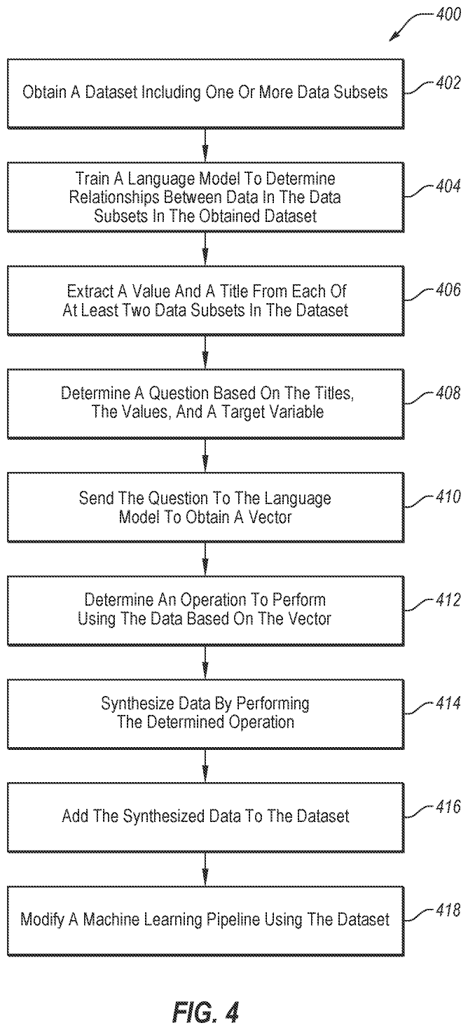

FIG. 4 illustrates a flow chart of an example method 400 of modifying a machine learning pipeline using a dataset including generated and/or synthesized data subsets, in accordance with one or more embodiments described in the present disclosure. The method 400 may be performed by any suitable system, apparatus, or device including the question generation module 104, the language module 106, and the feature engineering module of FIG. 1A, and/or the language training module 116 of FIG. 1B. The method 400 may include one or more blocks 402, 404, 406, 408, 410, 412, 414, 416, and 418. Although illustrated with discrete blocks, the steps and operations associated with one or more of the blocks of the method 400 may be divided into additional blocks, combined into fewer blocks, or eliminated, depending on the particular implementation.

In some embodiments, the method 400 may include block 402. At block 402, a dataset may be obtained where the dataset may include one or more data subsets. In some embodiments, the dataset may be analogous to the dataset 102 described and/or illustrated further in the present disclosure, such as, for example, with respect to FIGS. 1A and 1B.

At block 404, a language model may be trained to determine relationships between data included in the data subsets stored in the dataset. In some embodiments, the language model may be trained and/or fine-tuned using one or more question answer pairs. In some embodiments, the one or more question answer pairs may be generated by generating one or more semantic similarity distributions that may correspond to information between data subsets in the dataset. Further, one or more domains for the data subsets may be determined based on the one or more semantic similarity distributions satisfying a threshold. In some embodiments, one or more question answer pairs may be generated corresponding to the one or more domains, where the questions in the question answer pairs may compare data subsets within the same domain.

At block 406, a value and a title from each of at least two of the data subsets in the dataset. In some embodiments, the dataset may include or be analogous to the dataset 102 described further in the present disclosure, such as, for example, with respect to FIGS. 1A and 1B.

At block 408, a question may be determined based on the titles, the values, and a target variable. In some embodiments, the target variable may be inferred from data included in the dataset. In some embodiments, the target variable may be a task that a machine learning model may be configured to perform. In these and other embodiments, determining the question based on the titles, sample values, and/or the target variable may be described and/or illustrated further in the present disclosure, such as, for example, with respect to FIGS. 1A and 1B.

At block 410, the question may be sent to the language model to obtain a vector. In some embodiments, the vector that may be obtained from the language model may include one or more answers. In some embodiments, the one or more answers may include a “yes” or a “no” and each answer may include a corresponding probability distribution. In some embodiments, the one or more probability distributions may indicate whether the yes or no is a correct answer to the determined question. In some embodiments, the one or more answers may include a probability distribution that is included as a part of a sentiment analysis indicating whether one or more of the plurality of answers is positive or negative. In these and other embodiments, sending the question to the language model and receiving and/or obtaining one or more answers may be described and/or illustrated further in the present disclosure, such as, for example, with respect to FIGS. 1-3B.

At block 412, it may be determined that an operation may be performed using the data included in the at least two data subsets in the dataset. In some embodiments, the operation may be determined based on the vector received from the language model. In some embodiments, the determined operation may include one or more grouping operations where the grouping operations may be configured to analyze data may be combined from the at least two data subsets. For example, the grouping operations may include one or more of a maximum, a minimum, a skew, a sum, a standard deviation, a unique value, or most common value. In some embodiments, the determined operation may include one or more mathematical operations that generates new data corresponding to the dataset when the mathematical operations may be performed on the values in the two data subsets in the dataset. For example, the one or more mathematical operations may include one or more of subtraction, addition, multiplication, or division.

At block 414, data may be synthesized that may be related to the target variable. In some embodiments, the data may be synthesized by performing the determined operation using the data included in the at least two data subsets in the dataset. In some embodiments, the new data may be synthesized based on a level of confidence in the answer to the question satisfying a threshold.

At block 416, the synthesized data may be added to one or more new data subsets to the dataset. In some embodiments, the one or more new data subsets may include one or more new categorical data subsets and/or numerical data subsets described further in the present disclosure, such as, for example, with respect to FIGS. 1A, 1B, and 2.

At block 418, a machine learning pipeline may be modified using the dataset. In some embodiments, the modified machine learning pipeline may be configured to train one or more machine learning models using the dataset such that the machine learning model may make one or more predictions using new data.

Modifications, additions, or omissions may be made to the method 400 without departing from the scope of the present disclosure. For example, the operations of method 400 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

FIG. 5 illustrates a block diagram of an example computing system 502, according to at least one embodiment of the present disclosure. The computing system 502 may be configured to implement or direct one or more suitable operations described in the present disclosure. For example, the computing system 502 may be used in various elements of the above disclosure (e.g., the question generation module 102, the feature engineering module 110, the language model 106, the machine learning model 114, the language training module 116, and/or other systems capable of performing one or more operations or actions in the disclosed embodiments). In some embodiments, the computing system 502 may be used to control operations related to generating new data corresponding to a new data subset for the dataset. In these and other embodiments, the computing system 502 may be used to train a machine learning model using the dataset including the new data subset. The computing system 502 may include a processor 550, a memory 552, and a data storage 554. The processor 550, the memory 552, and the data storage 554 may be communicatively coupled.

In general, the processor 550 may include any suitable computer, computing entity, or processing device including various computer hardware or software modules and may be configured to execute instructions stored on any applicable computer-readable storage media. For example, the processor 550 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 550 may include any number of processors configured to, individually or collectively, perform or direct performance of any number of operations described in the present disclosure. Additionally, one or more of the processors may be present on one or more different electronic devices, such as different servers.

In some embodiments, the processor 550 may be configured to interpret and/or execute program instructions and/or process data stored in the memory 552, the data storage 554, or the memory 552 and the data storage 554. In some embodiments, the processor 550 may fetch program instructions from the data storage 554 and load the program instructions in the memory 552. After the program instructions are loaded into memory 552, the processor 550 may execute the program instructions.

The memory 552 and the data storage 554 may include computer-readable storage media for carrying or having computer-executable instructions or data structures stored thereon. For example, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to store particular program code in the form of computer-executable instructions or data structures and which may be accessed by a general-purpose or special-purpose computer. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007).

Combinations of the above may also be included within the scope of computer-readable storage media. Computer-executable instructions may include, for example, instructions and data configured to cause the processor 550 to perform a certain operation or group of operations.

Modifications, additions, or omissions may be made to the computing system 502 without departing from the scope of the present disclosure. For example, in some embodiments, the computing system 502 may include any number of other components that may not be explicitly illustrated or described.

Embodiments described in the present disclosure may be implemented using computer-readable media for carrying or having computer-executable instructions or data structures stored thereon. Such computer-readable media may be any available media that may be accessed by a general purpose or special purpose computer. For example, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

As used in the present disclosure, terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

We claim:

1. A system comprising:
one or more processors; and
one or more non-transitory computer-readable storage media configured to store instructions that, in response to being executed, cause the system to perform operations, the operations comprising:
obtaining a dataset including a plurality of data subsets;
training a language model to determine relationships between data in the data subsets in the obtained dataset using one or more question answer pairs;
extracting a value and a title from each of at least two data subsets in the dataset;
determining a question based on the titles, the values, and a target variable inferred from data included in the dataset;
sending the question to the language model to obtain a vector, the vector including a plurality of answers;
determining based on the vector, an operation to perform using the data included in the at least two data subsets in the dataset;
synthesizing data related to the target variable by performing the determined operation using the data included in the at least two data subsets in the dataset;
adding the synthesized data to one or more new data subsets to the dataset; and
modifying a machine learning pipeline using the dataset, the modified machine learning pipeline configured to train one or more machine learning models using the dataset to make predictions using new data.

2. The system of claim 1, wherein the one or more question answer pairs are generated by:
generating a plurality of semantic similarity distributions corresponding to information between data subsets in the dataset;
determining one or more domains for the data subsets in the dataset based on the plurality of sematic similarity distributions satisfying a threshold; and
generating one or more question answer pairs corresponding to the one or more domains, wherein questions in the question answer pairs compares data subsets with a same domain;

3. The system of claim 1, wherein the one or more new data subsets are synthesized based on a level of confidence in the answer to the question satisfying a threshold.

4. The system of claim 1, wherein the determined operation includes one or more grouping operations, the grouping operations configured to analyze data combined from the at least two data subsets.

5. The system of claim 4, wherein the grouping operations include one or more of a maximum, a minimum, a skew, a mean, a sum, a standard deviation, a unique value, or a most common value.

6. The system of claim 1, wherein the determined operation includes one or more mathematical operations that, when performed on the values in the two data subsets in the dataset, generates new data corresponding to the dataset.

7. The system of claim 6, wherein the one or more mathematical operations include one or more of subtraction, addition, multiplication, or division.

8. The system of claim 1, wherein each of the plurality of answers includes a probability distribution and the plurality of answers are either a yes or a no and the probability distribution indicates whether the yes or the no is a correct answer to the determined question.

9. The system of claim 1, wherein each of the plurality of answers includes a probability distribution and the probability distributions includes a sentiment analysis indicating whether one or more of the plurality of answers is positive or negative.

10. The system of claim 1, wherein the dataset including the added synthesized data is a second dataset and the dataset without the added synthesized data is a first dataset, the operations further comprising:
generating a plurality of comparison scores corresponding to data included in a plurality of pairs of data subsets in the second dataset, the plurality of comparison scores reflecting an overlap in similarity distributions between data included in one data subset and data included in another data subset in the plurality of pairs of data subsets in the second dataset;
filtering out of the second dataset, one or more pairs of data subsets based on one or more corresponding comparison scores of the plurality of comparison scores not satisfying a threshold;
generating a third dataset by restoring one or more data subsets that were filtered out of the second dataset and were present in the first dataset; and
training one or more machine learning models using the third dataset.

11. One or more non-transitory computer-readable storage media configured to store instructions that, in response to being executed, cause a system to perform operations, the operations comprising:
obtaining a dataset including a plurality of data subsets;
training a language model to determine relationships between data in the data subsets in the obtained dataset using one or more question answer pairs;
extracting a value and a title from each of at least two data subsets in the dataset;
determining a question based on the titles, the values, and a target variable inferred from data included in the dataset;
sending the question to the language model to obtain a vector, the vector including a plurality of answers;
determining based on the vector, an operation to perform using the data included in the at least two data subsets in the dataset;
synthesizing data related to the target variable by performing the determined operation using the data included in the at least two data subsets in the dataset;
adding the synthesized data to one or more new data subsets to the dataset; and
modifying a machine learning pipeline using the dataset, the modified machine learning pipeline configured to train one or more machine learning models using the dataset to make predictions using new data.

12. The one or more non-transitory computer-readable storage media of claim 11, wherein the one or more question answer pairs are generated by:
generating a plurality of semantic similarity distributions corresponding to information between data subsets in the dataset;
determining one or more domains for the data subsets in the dataset based on the plurality of sematic similarity distributions satisfying a threshold; and
generating one or more question answer pairs corresponding to the one or more domains, wherein questions in the question answer pairs compares data subsets with a same domain;

13. The one or more non-transitory computer-readable storage media of claim 11, wherein the one or more new data subsets are synthesized based on a level of confidence in the answer to the question satisfying a threshold.

14. The one or more non-transitory computer-readable storage media of claim 11, wherein the determined operation includes one or more grouping operations, the grouping operations configured to analyze data combined from the at least two data subsets.

15. The one or more non-transitory computer-readable storage media of claim 14, wherein the grouping operations include one or more of a maximum, a minimum, a skew, a mean, a sum, a standard deviation, a unique value, or a most common value.

16. The one or more non-transitory computer-readable storage media of claim 11, wherein the determined operation includes one or more mathematical operations that, when performed on the values in the two data subsets in the dataset, generates new data corresponding to the dataset.

17. The one or more non-transitory computer-readable storage media of claim 16, wherein the one or more mathematical operations include one or more of subtraction, addition, multiplication, or division.

18. The one or more non-transitory computer-readable storage media of claim 11, wherein each of the plurality of answers includes a probability distribution and the plurality of answers are either a yes or a no and the probability distribution indicates whether the yes or the no is a correct answer to the determined question.

19. The one or more non-transitory computer-readable storage media of claim 11, wherein each of the plurality of answers includes a probability distribution and the probability distributions includes a sentiment analysis indicating whether one or more of the plurality of answers is positive or negative.

20. The one or more non-transitory computer-readable storage media of claim 11, wherein the dataset including the added synthesized data is a second dataset and the dataset without the added synthesized data is a first dataset, the operations further comprising:
generating a plurality of comparison scores corresponding to data included in a plurality of pairs of data subsets in the second dataset, the plurality of comparison scores reflecting an overlap in similarity distributions between data included in one data subset and data included in another data subset in the plurality of pairs of data subsets in the second dataset;
filtering out of the second dataset, one or more pairs of data subsets based on one or more corresponding comparison scores of the plurality of comparison scores not satisfying a threshold;
generating a third dataset by restoring one or more data subsets that were filtered out of the second dataset and were present in the first dataset; and
training one or more machine learning models using the third dataset.
